(19) United States
(12) Patent Application Publication
(10) Pub. No.: US 2019/0389785 A1
(43) Pub. Date: Dec. 26, 2019

(54) CONTROLLED RELEASE NUTRIENTS BY COATING

(71) Applicant: Ningbo Weston Powder Pharma Coatings Co., Ltd., Ningbo (CN)

(72) Inventors: Qingliang Yang, Hangzhou (CN); Yingliang Ma, London (CA); Jingxu Zhu, London (CA); Kaiqi Shi, Ningbo (CN)

(21) Appl. No.: 16/030,209

(22) Filed: Jul. 9, 2018

(30) Foreign Application Priority Data
Jun. 21, 2018 (CN) 201810640481

(51) Int. Cl. C05G 3/00; C05C 11/00; C09D 101/04; C09D 133/10; C09D 7/63; C09D 7/61

(52) U.S. Cl. CPC C05G 3/0029; C05G 3/0035; C05G 3/0017; C09D 7/61; C09D 101/04; C09D 133/10; C09D 7/63; C05C 11/00

(57) ABSTRACT

The present disclosure provides a product of coated nutrients for controlled release, a method for coating the nutrients for controlled release and a coating composition for coating the nutrients for controlled release.

### FIELD

The present disclosure provides a product of coated nutrients for controlled release, and a method for coating the nutrients for controlled release and a coating composition for coating the nutrients for controlled release.

### BACKGROUND

A nutrient is a substance used by an organism to survive, grow, and reproduce. Some nutrients can be metabolically converted to smaller molecules in the process of releasing energy, such as for carbohydrates, lipids, proteins, and fermentation products (ethanol or vinegar), leading to end-products of water and carbon dioxide. Essential nutrients for animals are the energy sources, some of the amino acids that are combined to create proteins, a subset of fatty acids, vitamins and certain minerals.

When taken up into the human body from the diet, the 20 standard nutrients either are used to synthesize proteins and other biomolecules or are oxidized to urea and carbon dioxide as a source of energy. The oxidation pathway starts with the removal of the amino group by a transaminase; the amino group is then fed into the urea cycle. The other product of transamidation is a keto acid that enters the citric acid cycle. Glucogenic nutrients can also be converted into glucose, through gluconeogenesis. Of the 20 standard nutrients, nine (His, Ile, Leu, Lys, Met, Phe, Thr, Trp and Val) are called essential nutrients because the human body cannot synthesize them from other compounds at the level needed for normal growth, so they must be obtained from food. In addition, cysteine, taurine, tyrosine, and arginine are considered semi-essential amino-acids in children (though taurine is not technically an amino acid), because the metabolic pathways that synthesize these nutrients are not fully developed.

Sports nutrients are popular in strength sports (such as weightlifting and bodybuilding) and endurance sports (e.g. cycling, running, swimming, rowing). Common supplements to help athletes recover from exercising include protein and amino acid supplements. However, if too much protein and amino acid supplements are consumed in a short time, it can be more harmful than beneficial to human bodies. The health risks include dehydration, gout, calcium loss, liver and renal damage, diarrhea, bloating and water loss.

There is, thus, a need in the art to provide an extended and controlled supply of sports nutrients such as amino acids, vitamins, proteins and other nutrients to individuals without the necessity of intake of excess food and snacks.

Prior arts have been developed to produce liquid products of sustained release nutrients. In particular, several earlier attempts have been made to produce nutrient hydrogels for sustained release through polymeric crosslinking using free radical initiators, involving chemical reactions, which is very complicated with unstable liquid products.

Accordingly, it would be very advantageous to provide a stable coated solid product of controlled release nutrients, and a method for coating the nutrients for controlled release and a coating composition for coating the nutrients for controlled release.

### SUMMARY

The present disclosure provides a product of coated nutrients for controlled release and a method for coating the nutrients for controlled release and a coating composition for coating the nutrients for controlled release.

In an embodiment, the product of dry powder coated nutrients for controlled release, comprise (a) solids containing one or more biologically active agents; and, (b) one or more coatings that encapsulate solids of (a).

The solids comprise one or more biologically active agents and any other necessary ingredients include binders, fillers, anti-static agents, flow enhancing agents or any combination thereof.

The biologically active agents comprise one or more nutrients include carbohydrates, proteins, vitamins, fats, amino acids or any combination thereof.

The amino acids include branched chain amino acids, L-Leucin, L-Isoleucine, L-Valine, L-Glutamine, any other amino acids or any combination thereof.

The biologically active agents are in the form of coated or uncoated particles, powders, pellets, granules (i.e., an aggregate of smaller units of active agent) tablets, capsules or any combination thereof.

The coatings (i) comprise one or more film forming polymers; (ii) comprise one or more pore forming agents; (iii) comprise one or more plasticizers; (iv) are non-toxic.

The release of the biologically active agents is controlled by the coating, to a time period of 0.5-8 hours.

The release of the biologically active agents is controlled by the coating, to a time period of 1-6 hours.

The release of the biologically active agents is controlled by the coating, to a time period of 2-4 hours.

The coatings can be produced by any suitable coating process, including film coating using organic solvent or water with a fluidized bed such as Wurster fluidized bed (top spray, side spray and bottom spray) or a drum coater, also including a dry coating process such as hot-melt coating, photocuring coating, supercritical spray coating and dry powder coating.

In another embodiment, there is provided a process of producing dry powder coated nutrients, comprising:

a) preparing a dry powder film forming polymer coating composition, comprised of particles, to be coated onto an outer surface of the capsules, a size of the particles being in a range from about 1 nm to about 500 μm;

b) placing solids into an interior of a rotatable housing of a coater and preheating the solids;

c) spraying the dry powder film forming polymer coating composition into the interior to coat an outer surface of the solids;

d) rotating the rotatable housing to produce a uniform coating of the dry powder film forming polymer coating composition on the outer surface of the solids; and

e) curing the dry coated solids to form a substantially uniform cured film enveloping each solid.

The solids may be preheated to a temperature close to a glass transition temperature (Tg) of the polymer(s) contained in the film forming polymer coating composition, wherein the polymers are selected to have a glass transition temperature in a range from about 20 to about 200° C.

The glass transition temperature is in a range from about from 30 to about 100° C.

The glass transition temperature is in a range from about from about 40 to about 60° C.

The method may include spraying a suitable amount of plasticizer into the housing to comingle with the dry powder film forming polymer coating composition. The plasticizer may sprayed into the housing prior to spraying the dry powder film forming polymer coating composition, or it may be sprayed into the housing at the same time with spraying the dry powder film forming polymer coating composition.

The plasticizer may be any one or combination of a liquid pure plasticizer, a plasticizer in a solution, and a dry powder plasticizer.

During curing in the housing the coated solids may be cured at a temperature in a range from about 30 to about 100° C., and wherein a curing time is up to about 4 hours.

In another embodiment there is provided a composition for coating the nutrients for controlled release, which include one or more film forming polymers in a range from about 1 to about 100% w/w. The compositions include one or more plasticizers in quantity to lower the glass transition temperature of the coating composition to a temperature in a range from about 30 to 100° C. The compositions also include one or more one anti-static agents in a range from about 0.1 to about 90% w/w as well as one or more flow enhancing agents present in the composition in a range from about 0.1 to about 20% w/w.

The one or more film forming polymers may be present in the composition in a range from about 10 to about 80% w/w.

The one or more flow enhancing agents may be present in the composition in a range from about 0.25 to about 20% w/w.

The one or more flow enhancing agents may be present in the composition in a range from about 0.5 to about 3% w/w.

The one or more anti-static agents may be present in the composition in a range from about 1 to about 50% w/w.

The one or more plasticizers may include any one or combination of glycerol, propylene glycol, PEG 200 to 8000 grades, triacetin, diethyl phthalate (DEP), dibutyl phthalate (DBP), tributyl citrate (TBC), triethyl citrate(TEC), oleyl alcohol, castor oil, fractionated coconut oil, acetylated monoglycerides, glycerol monostearate. Plasticizers may also include low molecular weight polymers, oligomers, copolymers, oils, small organic molecules, low molecular weight polyols having aliphatic hydroxyls, ester-type plasticizers, glycol ethers, poly(propylene glycol), multi-block polymers, single block polymers, low molecular weight poly(ethylene glycol) and citrate ester-type plasticizers.

The one or more plasticizers may include any one or combination of ethylene glycol, 1,2-butylene glycol, 2,3-butylene glycol, styrene glycol, diethylene glycol, triethylene glycol, tetraethylene glycol and other poly(ethylene glycol) compounds, monopropylene glycol monoisopropyl ether, propylene glycol monoethyl ether, ethylene glycol monoethyl ether, diethylene glycol monoethyl ether, sorbitol lactate, ethyl lactate, butyl lactate, ethyl glycolate, dibutyl sebacate, acetyltributylcitrate, acetyl triethyl citrate and allyl glycolate.

The one or more anti-static agents may include common salts, carbon black, magnesium stearate, fumed silicate, magnesium trisilicate, glycerol monostearate, Kaolin, talc and a liquid plasticizer. The liquid plasticizer may include any one or combination of PEG 200 to 600, propylene glycol, glycerin, and triacetin. The common salts may include any one or combination of sodium chloride, calcium chloride, magnesium hydroxide, sodium carbonate, sodium bicarbonate, sodium phosphate, sodium citrate, sodium acetate, potassium acetate, potassium citrate, potassium chloride, and magnesium sulfate.

The plasticizer may be selected to lower the glass transition temperature of the coating composition to a temperature in a range from about 45 to 70° C.

The one or more flow enhancing agents may include any one or combination of calcium stearate, colloidal silicon dioxide, hydrogenate castor oil and microcrystalline cellulose, fumaric acid, glycerol behanate, glycerol monostearate, glycerol palmitostearate, leucine, magnesium stearate, medium chain triglyceride, myristic acid, palmitic acid, poloxamer, polyethylene glycol, potassium benzoate, sodium benzoate, sodium lauryl sulfate, sodium stearyl fumarate, starch, stearic acid, talc, hydrogenated vegetable oil and zinc stearate.

The one or more film forming polymers may be selected to exhibit any one or combination of a moisture barrier, immediate release, flavoring, taste modifying, and taste masking, and wherein the film forming polymer includes any one or combination of methylcellulose, hydroxyethyl cellulose, hydroxypropyl cellulose (HPC), hydroxylpropyl methyl cellulose (HPMC), polyethylene glycol, propylene glycol, polaxamer and povidone, polyvinyl alcohol based composition such as Opadry® AMB, Aminoalkyl methacrylate copolymers.

The one or more film forming polymers may be selected to exhibit extended release and includes any one or combination of cellulose ether derivative, acrylic resin, a copolymer of acrylic acid and methacrylic acid esters with quaternary ammonium groups, a copolymer of acrylic acid and methacrylic acid esters, ethyl cellulose, and poly(meth)acrylate polymers that are not soluble in digestive fluids.

The one or more film forming polymers may be selected to exhibit extended release and includes any one or combination of polyethylene oxide (PEO), ethylene oxide-propylene oxide co-polymers, polyethylene-polypropylene glycol (e.g. poloxamer), carbomer, polyvinyl pyrrolidone (PVP), polyvinyl alcohol (PVA), hydroxyalkyl celluloses such as hydroxypropyl cellulose (HPC), hydroxypropyl methylcellulose, sodium carboxymethyl cellulose, methylcellulose, hydroxyethyl methylcellulose, hydroxypropyl methylcellulose, polyacrylates such as carbomer, polyacrylamides, alginic acid and its derivatives, starch and starch derivatives, gelatin that are soluble in digestive fluids.

The poly(meth)acrylate polymers that are not soluble in digestive fluids may include any one or combination of Eudragit® RS polymers, Eudragit® RL polymers, and EUDRAGIT® NE polymers.

The dry powder film forming polymer coating composition may comprise any polymers that could provide flavoring or taste modifying/masking or moisture barrier include, but not limited to, methylcellulose, hydroxyethyl cellulose, hydroxypropyl cellulose (HPC), hydroxylpropyl methyl cellulose (HPMC) and so on to give a few non-limiting examples.

The dry powder film forming polymer coating composition may comprise water soluble polymers that achieve instant or immediate drug release, comprising, but not limited to, methylcellulose, hydroxyethyl cellulose, hydroxypropyl cellulose (HPC), hydroxylpropyl methyl cellulose (HPMC), poly(vinylpyrrolidinone) (PVP), polyethylene glycols such as but not limited to PVP, PEG 400, PEG 600, PEG 3350, propylene glycol, polaxamer and povidone or any combination thereof.

The dry powder film forming polymer coating composition may comprise water insoluble polymers that achieve sustained or controlled drug release, comprising, but not limited to, cellulose acetate, ethylcellulose and cellulose derivatives such as cellulose nitrate, cellulose acetate ethyl carbamate, cellulose acetate phthalate, cellulose acetate methyl carbamate, cellulose acetate succinate, cellulose acetate dimethaminoacetate, cellulose acetate ethyl carbonate, cellulose acetate chloroacetate, cellulose acetate ethyl oxalate, Eudragit® RL, Eudragit® RS or any combination thereof.

The dry powder film forming polymer coating composition may comprise plasticizers, anti-tacky agents, pore forming agents or other additives, or any combination thereof.

A further understanding of the functional and advantageous aspects of the present disclosure can be realized by referring to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 displays a dissolution profile of branched amino acid (BCAA) from powder coated beads of Example 1 with ethylcellose; (Coating level 20%; pH 7.2).

FIG. 2 displays a dissolution profile of branched amino acid (BCAA) from powder coated beads of Example 2 with Eudragit® RS (Coating level 20%; pH 7.2).

### DETAILED DESCRIPTION

Various embodiments and aspects of the disclosure will be described with references and details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, the terms “comprises” and “comprising” and variations thereof mean the specified features, steps or components are included, when they are used in the specifications and claims. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

The term “solids” refers to the solid nutrient substrate containing biologically active agents such as amino acids, proteins, vitamins, and any other necessary ingredients including binders, fillers, anti-static agents, flow enhancing agents or any combination thereof.

The phrases “film forming coating powder composition” and/or “film forming polymer powder” refer to the mixture of powders being used to form the coating on the nutrients solids and can optionally include other constituents or materials.

The phrase “pore forming agent” refers to the powdered polymers, or liquid polymers, or polymer solutions with small molecular weight that can be used as the pore forming agent in the pharmaceutical coating process. Pore forming agents are water soluble materials which can be sprayed together with coating powders including film forming materials in the powder coating process. After being cured, they would be part of the coating film. After being swallowed and upon contacting with GI tract, those pore forming agents are dissolved and leached out, leaving lots of small holes (micropores) on the film, hence the coating film becomes permeable allowing fluids to move into and dissolve the solids thereby releasing the active nutrients.

The phrase “micropores” refers to the pores located on the coating film formed by the pore forming agent during coating process, ranged from 1 nm to 100 μm, preferably from 10 nm to 10 μm, more preferably from 50 nm to 5 μm.

The term “curing” refers to applying an energy source, examples being a heat source such as a heater or an infrared source, or an energy source such as an ultraviolet source, to increase the temperature of the coated solids, so as to solidify or partially solidify a powder coating applied to the surface of the solids. This heat source can be a hot air flowing through the drum, or a heating element inside the housing but close enough to be able to transfer heat to the drum.

The term “powder coating” refers to a method process to coat solids with film forming powder composition, in other words it refers to a method of forming a film coating around a substrate. The “powder coating” also refers to the particle product coated with film forming polymer powder composition.

Eudragit® is a trade mark of Evonik and Acryl-EZE® is a trade mark of Colorcon.

The present disclosure provides a product of coated nutrients for controlled release and a method for coating the nutrients for controlled release and a coating composition for coating the nutrients for controlled release.

In an embodiment, the product of dry powder coated nutrients for controlled release, comprise (a) solids containing one or more biologically active agents; and, (b) one or more coatings that encapsulate solids of (a).

The solids comprise one or more biologically active agents and any other necessary ingredients including binders, fillers, anti-static agents, flow enhancing agents or any combination thereof.

The biologically active agents comprise one or more nutrients including carbohydrates, proteins, vitamins, fats, amino acids or any combination thereof.

The amino acids include branched chain amino acids, L-Leucin, L-Isoleucine, L-Valine, L-Glutamine, any other amino acids or any combination thereof.

The biologically active agents are in the form of coated or uncoated particles, powders, pellets, granules (i.e., an aggregate of smaller units of active agent), tablets, capsules or any combination thereof.

The coatings (i) comprise one or more film forming polymers; (ii) comprise one or more pore forming agents; (iii) comprise one or more plasticizers; (iv) are non-toxic.

The release of the biologically active agents is controlled by the coating, to a time period of 0.5-8 hours.

The release of the biologically active agents is controlled by the coating, to a time period of 1-6 hours.

The release of the biologically active agents is controlled by the coating, to a time period of 2-4 hours.

The coatings can be produced by any suitable coating process, including film coating using organic solvent or water with a fluidized bed such as Wurster fluidized bed (top spray, side spray and bottom spray) or a drum coater, also including a dry coating process such as hot-melt coating, photocuring coating, supercritical spray coating and dry powder coating.

In another embodiment there is provided a process of producing dry powder coated nutrients, comprising:

A) Preparation of the powdered coating material is the first step, and in an embodiment the coating powder may be milled using a suitable mill such as an airjet mill, grinder ball mill, pin mill, hammering mill or combination thereof to produce particles in a preselected size range. The particle size of coating powder can be in a range of about 1 nm to about 200 μm, preferably in a range of about 10 to about 100 μm, and more preferably in a range from about 20 to about 40 μm. After particle size reduction, those coating materials are mixed together to form a coating formulation.
B) Positioning and preheating is accomplished by loading the solids into a rotatable housing which has been preheated to a temperature close to the glass transition temperature (T_{g}) of the coating polymers, which is typically in a range from about 30 to about 100° C., preferably from about 30 to about 80° C., more preferably from about 40 to about 60° C.
C) During the process of coating powder deposition, the adhesion of the coating powders may need the assistance of a suitable amount of dry powdered plasticizer, or liquid plasticizer or plasticizer solution with a weight ratio range of 0% to about 200% based on weight of the film forming coating powders, preferably in a range from about 5% to about 100%, more preferably in a range from about 10% to about 80%, and in particular preferably in a range of about 20% to about 60%. Plasticizer(s), when they are present, and film forming coating powders are sprayed onto the surface of the solids using an air atomizing or airless spray nozzle/electrostatic spray gun (e.g. corona charging gun or a tribo charging gun). If corona gun is used, the voltage can be in a range of about 20 to about 120 kV, preferably in a range of about 25 to about 70 kV, more preferably in a range of about 40 to about 70 kV, and particular preferably in a range of about 50 to about 70 kV. The plasticizer and coating powders may be sprayed either simultaneously, or via the alternating spray method wherein the plasticizer or powdered polymer material is sprayed first and then the other is sprayed and the process may be repeated.

Alternatively, plasticizer can be mixed with powdered material and then this mixture can be sprayed onto the solids. In all cases, heating preferably continues during the spraying of plasticizer and powdered materials.

D) After the deposition of coating powders, solids remains in the rotatable housing under a curing temperature, which is in a range from about 30 to about 100° C., preferably from 30 to 80° C., more preferably from about 40 to about 60° C., for a period of time ranged from 0 to about 10 hours, preferably from about 0 to about 4 hours, more preferably from about 1 to about 2 hours, to allow those deposited coating powders to coalesce and form the coating film.

The solids will contain at least one nutrient (biologically active agent). Typical biologically active agents include, but are not limited to, e.g. carbohydrates, proteins, vitamins, fats, amino acids, or any combination thereof. The amino acids include branched chain amino acids, L-Leucin, L-Isoleucine, L-Valine, L-Glutamine, or any other amino acids, or any combination thereof.

The solid can be in any suitable form. For example, it can be in the form of a powder, a pellet, a granule (i.e., an aggregate of smaller units of active agent), a small tablet or any combination thereof.

The solids may also include one or more functional excipients such as compressible agent, lubricants, thermal lubricants, antioxidants, binders, diluents, osmotic agents, sweeteners, chelating agents, colorants, flavorants, surfactants, solubilizers, wetting agents, stabilizers, hydrophilic polymers, hydrophobic polymers, waxes, lipophilic materials, absorption enhancers, protease inhibitors, preservatives, absorbents, cross-linking agents, bioadhesive polymers, retardants, and fragrance.

The film forming polymers may be chosen to provide flavoring or taste modifying/masking or moisture barrier include, but not limited to, methylcellulose, hydroxyethyl cellulose, hydroxypropyl cellulose (HPC), hydroxylpropyl methyl cellulose (HPMC) and so on to give a few non-limiting examples.

The film forming polymers may include water soluble polymers comprising, but not limited to, methylcellulose, hydroxyethyl cellulose, hydroxypropyl cellulose (HPC), hydroxylpropyl methyl cellulose (HPMC), and poly(vinylpyrrolidinone) (PVP), polyethylene glycols such as but not limited to PVP, PEG 400, PEG 600, PEG 3350, propylene glycol, polaxamer and povidone, or any combination thereof;

The film forming polymers may include water insoluble polymers comprising, but not limited to, cellulose acetate, ethylcellulose and cellulose derivatives such as cellulose nitrate, cellulose acetate ethyl carbamate, cellulose acetate phthalate, cellulose acetate methyl carbamate, cellulose acetate succinate, cellulose acetate dimethaminoacetate, cellulose acetate ethyl carbonate, cellulose acetate chloroacetate, cellulose acetate ethyl oxalate, Eudragit® RL, Eudragit® RS, or any combination thereof.

The film forming polymers may include pH dependent polymers that are insoluble in aqueous medium at pH lower than 5.5 comprising, but not limited to, cellulose acetate phthalate, cellulose acetate trimaletate, hydroxyl propyl methylcellulose phthalate, polyvinyl acetate phthalate, acrylic polymers, polyvinyl acetaldiethylamino acetate, hydroxypropyl methylcellulose acetate succinate, cellulose acetate trimellitate, shellac, methacrylic acid copolymers, Eudragit® L30D, Eudragit® L100, Eudragit® FS30D, Eudragit® S 100, hydroxypropyl methylcellulose acetate succinate, or any combination thereof;

The composition of the coating powders may also include pore forming agents, plasticizers, anti-tacky agents, pigments and other additives such as coating powder glidants, or any combination thereof.

Exemplary pore forming agents include water soluble polymers such as methylcellulose, hydroxyethyl cellulose, hydroxypropyl cellulose (HPC), hydroxylpropyl methyl cellulose (HPMC), poly(vinylpyrrolidinone) (PVP), polyethylene glycols such as but not limited to PVP, PEG 400, PEG 600, PEG 3350, propylene glycol, polaxamer and povidone; binders such as lactose, calcium sulfate, calcium phosphate and the like; salts such as sodium chloride, magnesium chloride and the like to give a few examples, and any combination thereof and other similar or equivalent materials which are widely known in the art.

Plasticizers are used to reduce the glass transition temperature of the coating polymer. Plasticizer can be solid, liquid or plasticizer solution. When the plasticizer is liquid polymers or polymer solutions, it can also be used to decrease the electrical resistivity of the capsule so that the adhesion of coating powder and the coating efficiency could be promoted. Furthermore, liquid plasticizers or plasticizer solutions can provide a strong capillary force between particles and surface of the solid, hence enhancing coating powder adhesion. Plasticizers suitable for use in the present invention include, but are not limited to glycerol, propylene glycol, PEG 200-600 grades, triacetin, diethyl phthalate (DEP), dibutyl phthalate (DBP) and tributyl citrate (TBC), triethyl citrate (TEC) and so on.

### Example 1

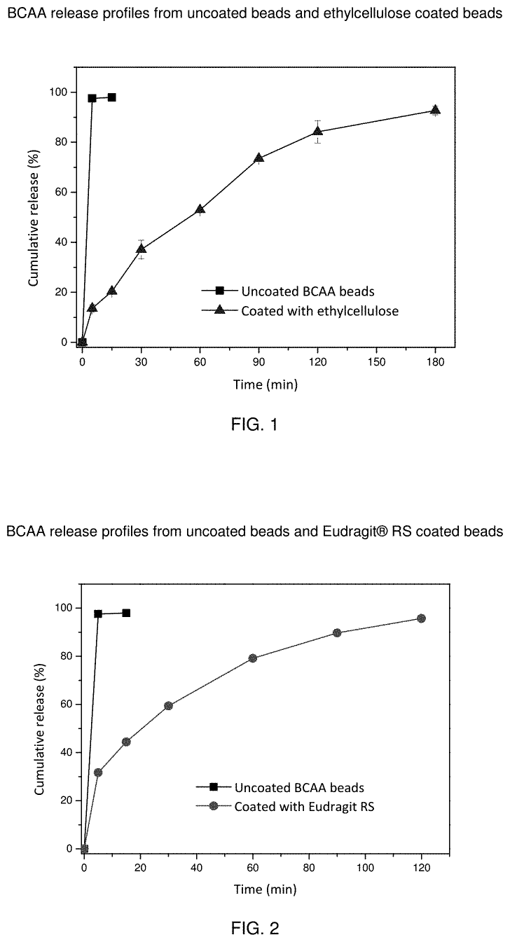

This example illustrates the preparation of powder coated branch amino acid (BCAA) in accordance with the invention. The composition of the formulation is provided in Table 1. The dissolution profile of the powder coated BCAA beads is presented in FIG. 1.

TABLE 1
Composition of ethylcellulose powder coated branch
amino acid (BCAA) for controlled release

| | | |
|---|---|---|
| Ingredient | Function | % w/w |

Composition of BCAA particles

| | | |
|---|---|---|
| Branch amino acid (BCAA) | Active agent | 98.5 |
| Hydroxypropyl methylcellulose | Binder | 1.5 |
| (HPMC) | | |

Dry powder coating formulation for Example 1

| | | |
|---|---|---|
| Ethylcellulose | Film forming polymer | 50 |
| Lactose | Plasticizer | 20 |
| Triethyl citrate(TEC) | Plasticizer | 20 |
| Talc powder | Anti-tacky agents | 9.5 |
| Pigment (FD&C Blue # 1) | Colorant | 0.5 |
| Colloidal silicone dioxide | Glidant | 0.5 |

Weight gain (Coating level) = 20%

The method for manufacturing the powder coated BCAA beads were as follows. BCAA and hydroxypropyl methylcellulose were blended until homogenous. Then the mix was granulated in a wet granulator followed by a drying process in a fluidized bed. Powder film coating material was milled using suitable milling equipment, such as an air jet mill, to achieve a particle size of less than approximately 20 μm.

The granulated BCAA beads were preheated in a non-perforated coating pan to approximately 50° C.

The plasticizer was then sprayed onto the rolling capsules at approximately 0.5 g per minute. The powdered coating material was then deposited onto the beads by using a corona charging gun at a rate of 1 to 1.5 g per minute at a setting of 0 kilo Volts (kV). The cycle of plasticizer coating and powdered coating material deposition was repeated until the target coating level was reached.

The coated BCAA beads were cured at 50° C. for 60-90 mins.

The USP dissolution test was performed in conditions designed to mimic the environment of the intestine that is encountered by an oral composition that is swallowed by a human with an aqueous solution, at 7.2±0.05 typically pH 7.2.

As shown in FIG. 1, compared with uncoated BCAA beads, the powder coated BCAA beads exhibit a prolonged release profile at a relatively constant release rate.

### Example 2

A controlled release BCAA beads was prepared using the powder coating method presented in this invention and extended release coating material of the compositions provided in EXAMPLE 1 and Table 2, respectively.

TABLE 2
Dry powder coating formulation for Example 2

| Ingredient | Function | % w/w |
|---|---|---|
| Eugragit RS | Film forming polymer | 60 |
| Triethyl citrate(TEC) | Plasticizer | 20 |
| Talc powder | Anti-tacky agents | 19.5 |
| Pigment (FD&C Yellow # 1) | Colorant | 0.5 |
| Colloidal silicone dioxide | Glidant | 0.5 |

Weight gain (Coating level) = 20%

As shown in FIG. 2, the dissolution profile suggests that the BCAA can be released for up to 120 mins at a close to zero-order rate.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A product of dry powder coated nutrients for controlled release, comprising (a) solids containing one or more biologically active agents; and, (b) one or more coatings that encapsulate the solids of (a).

2. The product according to claim 1 wherein the said solids contain one or more biologically active agents and any other necessary ingredients including binders, fillers, anti-static agents, flow enhancing agents or any combination thereof.

3. The product according to claim 1 wherein the one or more biologically active agents are one or more nutrients including carbohydrates, proteins, vitamins, fats, amino acids, or any combination thereof.

4. The product according to claim 3 wherein the amino acids include branched chain amino acids, L-Leucin, L-Isoleucine, L-Valine, L-Glutamine, or any other amino acids, or any combination thereof.

5. The product according to claim 1 wherein the one or more biologically active agents are in the form of coated or uncoated particles, powders, pellets, granules (i.e., an aggregate of smaller units of active agent), tablets, capsules or any combination thereof.

6. The product according to claim 1 wherein the wherein the one or more coatings (i) comprise one or more film forming polymers; (ii) comprise one or more pore forming agents; (iii) comprise one or more plasticizers.

7. The product according to claim 1 wherein the release of the biologically active agents is controlled by the one or more coating that encapsulates the solids, to a time period of 0.5-8 hours, preferably to a time period of 1-6 hours, more preferably to a time period of 2-4 hours.

8. The product according to claim 1 wherein the coatings can be produced by any suitable coating process, including film coating using organic solvent or water with a fluidized bed such as Wurster fluidized bed (top spray, side spray and bottom spray) or a drum coater, also including a dry coating process such as hot-melt coating, photocuring coating, supercritical spray coating and dry powder coating.

9. A method to produce dry powder coated nutrients for controlled release from solids containing one or more biologically active agents, comprising:
preparing a dry powder film forming polymer coating composition, comprised of particles, to be coated onto an outer surface of the biologically active agents, a size of the particles being in a range from about 1 nm to about 500 μm;
placing the solids into an interior of a rotatable housing of a coater and preheating the solids;
spraying the dry powder film forming polymer coating composition into the interior of the rotatable housing to coat the outer surface of the solids;
rotating the rotatable housing to produce a uniform coating of the dry powder film forming polymer coating composition on the outer surface of the solids, thus forming coated solids; and
curing the coated solids to form a substantially uniform cured film enveloping each solid.

10. The method according to claim 9 wherein the solids are preheated to a temperature close to a glass transition temperature (Tg) of the polymer(s) contained in said dry powder film forming polymer coating composition, wherein said polymers are selected to have a glass transition temperature in a range from about 20 to about 200° C., preferably in a range from about from 30 to about 100° C., more preferably in a range from about from 40 to about 60° C.

11. The method according to claim 9, including spraying a plasticizer into said rotatable housing during spraying of the dry powder film forming polymer coating composition, said suitable amount of plasticizer being selected to reduce a glass transition temperature (Tg) of the dry powder film forming polymer coating composition to a range between about 30 to about 100° C.

12. The method according to claim 11, wherein said plasticizer is sprayed into the rotatable housing prior to spraying the dry powder film forming polymer coating composition.

13. The method according to claim 11, wherein said plasticizer is sprayed into the rotatable housing at the same time with spraying the dry powder film forming polymer coating composition.

14. The method according to claim 11, wherein said plasticizer is pre-mixed with the said dry powder film forming polymer coating composition, then sprayed into the rotatable housing.

15. The method according to claim 11, wherein said plasticizer is any one or combination of a liquid pure plasticizer, a plasticizer in a solution, and a dry powder plasticizer.

16. The method according to claim 9, wherein during curing in the rotatable housing the coated solids are cured at a temperature in a range from about 30 to about 100° C., and wherein a curing time is up to about 4 hours.

17. The method according to claim 16, wherein during curing in the housing the coated solids are cured at a temperature in a range from about 40 to about 60° C.

18. A dry powder coating composition having a glass transition temperature (Tg) to be coated onto an outer surface of solids containing one or more biologically active solids for controlled release, comprising:
a) one or more film forming polymers in powder form present in the coating composition in a range from about 1 to about 100% w/w;
b) one or more plasticizers in powder or liquid form present in the coating composition in quantity to lower the glass transition temperature (Tg) of the coating composition to a temperature in a range from about 30 to 100° C.;
c) one or more one anti-static agents in powder or liquid form present in the coating composition are in a range from about 0.1 to about 90% w/w; and
d) one or more flow enhancing agents in powder form present in the coating composition are in a range from about 0.1 to about 20% w/w.

19. The coating composition according to claim 18, wherein the one or more film forming polymers present in the coating composition are in a range from about 10 to about 80% w/w.

20. The coating composition according to claim 18, wherein the one or more flow enhancing agents present in the coating composition are in a range from about 0.25 to about 20% w/w.

21. The coating composition according to claim 18, wherein the one or more flow enhancing agents present in the coating composition are in a range from about 0.5 to about 3.0% w/w.

22. The coating composition according to claim 18, wherein the one or more anti-static agents present in the coating composition are in a range from about 1 to about 50% w/w.

23. The coating composition according to claim 18, wherein the one or more plasticizers include any one or combination of glycerol, propylene glycol, PEG 200 to 8000 grades, triacetin, diethyl phthalate (DEP), dibutyl phthalate (DBP), tributyl citrate (TBC), triethyl citrate (TEC), castor oil, fractionated coconut oil, acetylated monoglycerides, glycerol monostearate, oligomers, copolymers, oils, small organic molecules, low molecular weight polyols having aliphatic hydroxyls, ester-type plasticizers, glycol ethers, poly(propylene glycol), multi-block polymers, single block polymers, low molecular weight poly(ethylene glycol) and citrate ester-type plasticizers,

24. The coating composition according to claim 18, wherein the one or more plasticizers include any one or combination of ethylene glycol, 1,2-butylene glycol, 2,3-butylene glycol, styrene glycol, diethylene glycol, triethylene glycol, tetraethylene glycol and other poly(ethylene glycol) compounds, monopropylene glycol monoisopropyl ether, propylene glycol monoethyl ether, ethylene glycol monoethyl ether, diethylene glycol monoethyl ether, sorbitol lactate, ethyl lactate, butyl lactate, ethyl glycolate, dibutyl sebacate, acetyltributylcitrate, acetyl triethyl citrate and allyl glycolate.

25. The coating composition according to claim 18, wherein the one or more anti-static agents include common salts, carbon black, magnesium stearate, fumed silicate, magnesium trisilicate, glycerol monostearate, Kaolin, talc and a liquid plasticizer.

26. The coating composition according to claim 25, wherein said liquid plasticizer includes any one or combination of PEG 200 to 600, propylene glycol, glycerin, and triacetin.

27. The coating composition according to claim 25, wherein said common salts include any one or combination of sodium chloride, calcium chloride, magnesium hydroxide, sodium carbonate, sodium bicarbonate, sodium phosphate, sodium citrate, sodium acetate, potassium acetate, potassium citrate, potassium chloride, and magnesium sulfate.

28. The coating composition according to claim 18, wherein said plasticizer is selected to lower the glass transition temperature (Tg) of the coating composition to a temperature in a range from about 40 to 70° C.

29. The coating composition according to claim 18, wherein the one or more flow enhancing agents include any one or combination of calcium stearate, colloidal silicon dioxide, hydrogenate castor oil and microcrystalline cellulose, fumaric acid, glycerol behenate, glycerol monostearate, glycerol palmitostearate, leucine, magnesium stearate, medium chain triglyceride, myristic acid, palmitic acid, poloxamer, polyethylene glycol, potassium benzoate, sodium benzoate, sodium lauryl sulfate, sodium stearyl fumarate, starch, stearic acid, talc, hydrogenated vegetable oil and zinc stearate.

30. The coating composition according to claim 18, wherein the one or more film forming polymers are selected to exhibit any one or combination of a moisture barrier, immediate release, flavoring, taste modifying, and taste masking, and wherein the film forming polymer includes any one or combination of methylcellulose, hydroxyethyl cellulose, hydroxypropyl cellulose (HPC), hydroxylpropyl methyl cellulose (HPMC), polyethylene glycol, propylene glycol, polaxamer and povidone, polyvinyl alcohol based composition such as Opadry® AMB, Aminoalkyl methacrylate copolymers.

31. The coating composition according to claim 18, wherein the one or more film forming polymers are selected to exhibit extended release and includes any one or combination of cellulose ether derivative, acrylic resin, a copolymer of acrylic acid and methacrylic acid esters with quaternary ammonium groups, a copolymer of acrylic acid and methacrylic acid esters, ethyl cellulose, and poly(meth)acrylate polymers that are not soluble in digestive fluids.

32. The coating composition according to claim 31, wherein the poly(meth)acrylate polymers that are not soluble in digestive fluids include any one or combination of Eudragit® RS polymers, Eudragit® RL polymers, and EUDRAGIT® NE polymers.

33. The coating composition according to claim 18, wherein the one or more film forming polymers are selected to exhibit extended release and includes any one or combination of polyethylene oxide (PEO), ethylene oxide-propylene oxide co-polymers, polyethylene-polypropylene glycol (e.g. poloxamer), carbomer, polyvinyl pyrrolidone (PVP), polyvinyl alcohol (PVA), hydroxyalkyl celluloses such as hydroxypropyl cellulose (HPC), hydroxypropyl methylcellulose, sodium carboxymethyl cellulose, methylcellulose, hydroxyethyl methylcellulose, hydroxypropyl methylcellulose, polyacrylates such as carbomer, polyacrylamides, alginic acid and its derivatives, starch and starch derivatives, gelatin that are soluble in digestive fluids.

34. The coating composition according to claim 18, applied multiple times to the dosages with each different coating selected to have a pre-determined functionality.
